(19) United States
(12) Patent Application Publication
(10) Pub. No.: US 2004/0099155 A1
(43) Pub. Date: May 27, 2004

(54) Equiment for the automatic tray positioning of articles, in particular sausages or other alimentary products

(76) Inventor: Giovanni Battista Righele, Zane (IT)

Correspondence Address: JACOBSON HOLMAN PLLC, 400 SEVENTH STREET N.W., SUITE 600, WASHINGTON, DC, 20004, US

(21) Appl. No.: 10/473,145

(22) PCT Filed: Oct. 31, 2002
(86) PCT No.: PCT/EP02/12175

(30) Foreign Application Priority Data
Jan. 18, 2002 (IT) 2002A 000089

(51) Int. Cl. A01J 11/00

(52) U.S. Cl. 99/468

(57) ABSTRACT

The invention concerns an equipment for the automatic tray positioning of single cylindrical or spherical pieces, in particular sausages or other alimentary products. The equipment comprises a first conveyor for the feeding of a sequence of single pieces along a first direction and a second intermittent advancement conveyor or the feeding of single trays along a second direction substantially perpendicular to said first direction. There are also provided a first sensor for the detection of the passage of the single pieces, a second sensor for the detection of the passage of the single trays, and an electronic control device that receives signals from said sensors and controls an advancement step of said second conveyor, with pre-established delay and in measure at least equal to the width of said pieces, at each pre-established number of passages of the pieces in correspondence of said first sensor and a further advancement step of said second conveyor, up to a position determined by said second sensor and suitable to allow to the next empty tray to receive a first piece from said first conveyor, at each predetermined multiple of said pre-established number of passages of pieces in correspondence of said first sensor. An oscillating blade located at the output of said first conveyor provides to the alignment of single pieces at the moment of their entrance into the tray.

### DESCRIPTION

The present invention concerns an equipment for the automatic tray positioning of single pieces, in particular sausages or other alimentary products.

The equipment according to the invention comprises a first conveyor for the feeding of a sequence of single pieces along a first direction, a second intermittent advancement conveyor for the feeding of single trays along a second direction substantially perpendicular to said first direction, a first sensor for the detection of the passage of single pieces, a second sensor for the detection of the passage of the single trays, and an electronic control device which receives commands from said sensors and controls an advancement step of said second conveyor, with pre-established delay and in measure at least equal to the width of said pieces, at each pre-established number of passages of pieces in correspondence of said first sensor and a further advancement step of said second conveyor, up to a position established by said second sensor and suitable to allow the next empty tray to receive a first piece from said first conveyor, at each predetermined multiple of said pre-established number of passages of pieces in correspondence of said first sensor. The equipment is characterised in that the second conveyor has a substantially horizontal path and the first conveyor has an output chute with an output end substantially parallel to the bottom of the trays.

An oscillating blade is preferably positioned at the output of said first conveyor for the alignment of the pieces at the moment of their entrance into the tray.

An embodiment of the equipment according to the present invention is illustrated as a non limiting example in the enclosed drawings, in which:

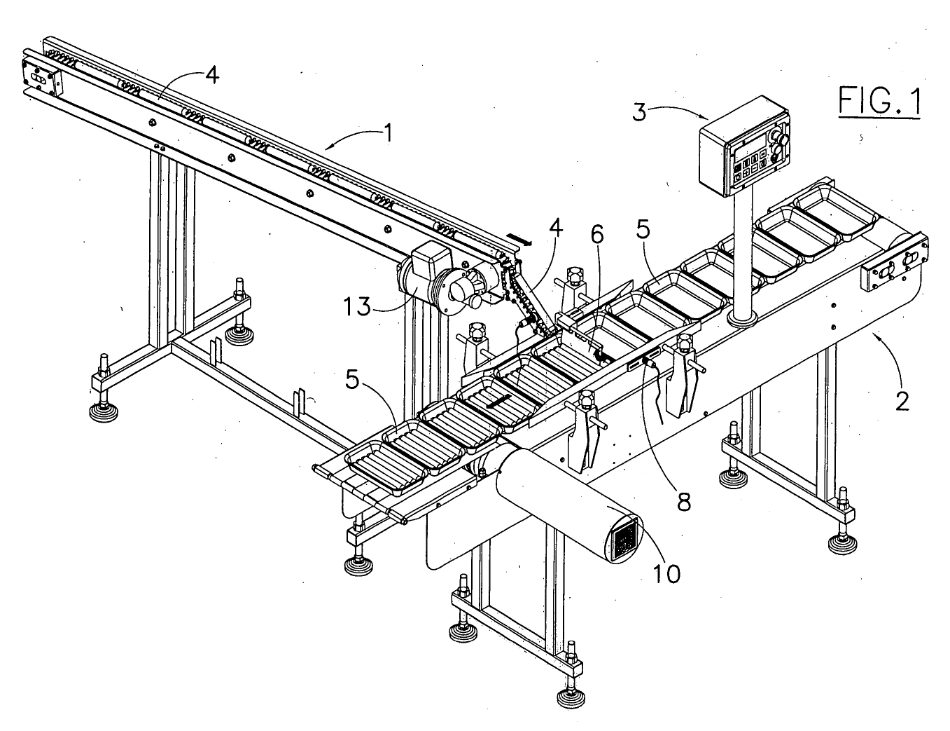

FIG. 1 shows in an overall perspective view an equipment according to the invention, provided for the positioning of cylindrical pieces;

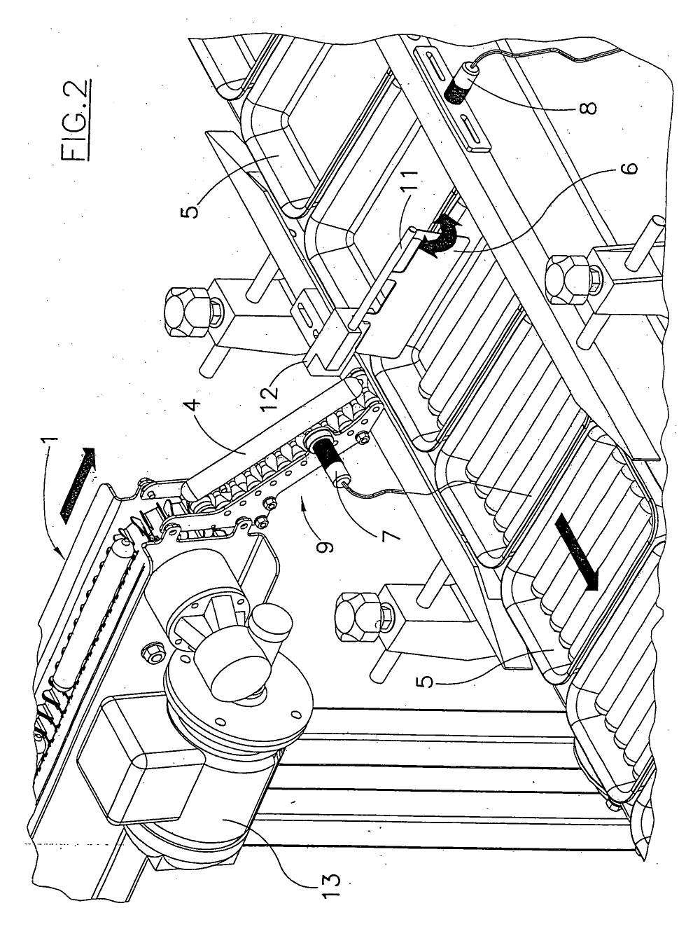

FIG. 2 shows a magnified detail of said equipment, still in perspective view;

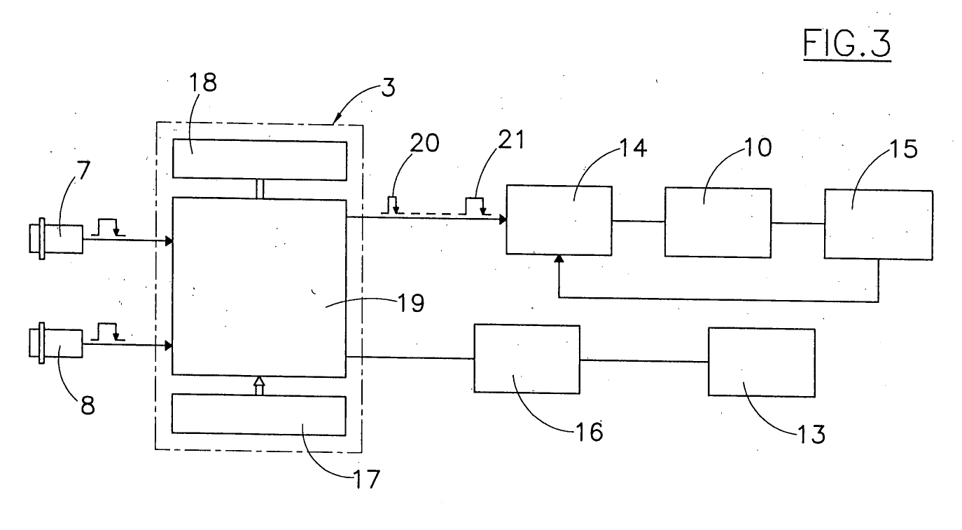

FIG. 3 shows the scheme of principle of the control system comprised in the aforesaid equipment;

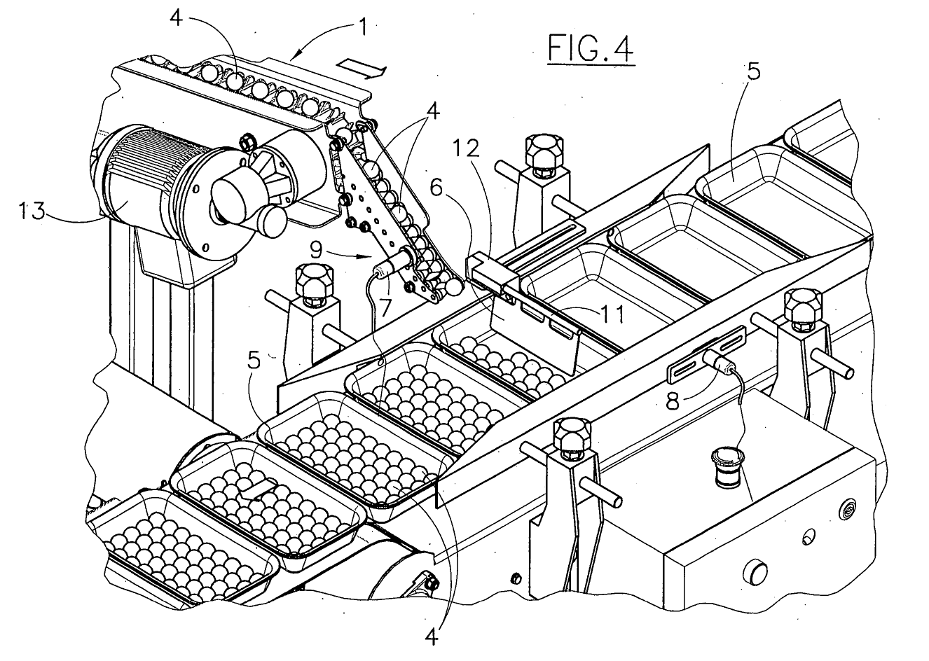

FIG. 4 shows a variation of the equipment according to the invention, provided for the positioning of spherical pieces.

The equipment illustrated in FIGS. 1-3 is specifically addressed to the insertion of a plurality of cylindrical sausages 4 inside trays 5.

The equipment comprises a first conveyor 1 for the conveying of single loose sausages 4 along a first feeding direction and up to an output chute 9 and a second conveyor 2 for the conveying of the trays 5 along a second feeding direction substantially perpendicular to the first one.

The conveyor 1 is set in motion by an electric motor 13 provided with an inverter 16 (FIG. 3) and the conveyor 2 is set in motion by a step-by-step electric motor 10, in particular by a direct current motor provided with starter 14 and tachometric dynamo 15 (FIG. 3).

To the chute 9 a first optical sensor 7 is associated that detects the passage of sausages 4 and to the conveyor 2 a second optical sensor 8 is associated that detects the passage of the trays 5.

An oscillating blade 6 is located at the output of the chute 9 in order to allow the alignment of the single sausages that fall into the tray. The blade 6 is rotatably mounted on a hinge 11 that is fastened onto a fixed support 12 and positioned transversally to the feeding direction of the conveyor 2.

Finally an electronic control device 3 is provided, whose scheme of principle is illustrated in FIG. 3 and comprises a group of buttons 17, a visual display unit 18 and a microprocessor 19 that receives signals from the sensors 7 and 8 and controls the motors 10 and 13 as a function of these.

More precisely, once the equipment has been started through an appropriate button 17, the microprocessor controls the running of the motor 13 for the continuous feeding of loose sausages 4, in sequence one after the other, along the conveyor 1. Through the chute 9 the sausages 4 fall inside the trays 5 one at the time with the alignment allowed by the oscillating blade 6.

Before falling in the tray each single sausage passes in front of the sensor 7, that sends a corresponding signal to the microprocessor 19, that in turn, with a pre-established time delay, gives the motor 10 a command 20 such as to cause an advancement step of the conveyor 2 in measure at least equal to the diameter or width of the sausages 4, in such a way so as to allow the following sausage to get parallel next to the previous sausage.

After a predetermined number of such cycles, that is of each predetermined multiple of said pre-established number of passages in front of the sensor 7, corresponding to the complete filling of the tray, the microprocessor 19 (opportunely provided with the possibility to count) gives the motor 10 a command 21 such as to cause a further advancement step of the conveyor 2 up to a position established by the sensor 8, corresponding to the positioning of a next empty tray at the output of the chute 9, in a position suitable to receive a first sausage from the conveyor 1. The cycle goes on with the filling of the new tray.

At the same time the blade 6, in order to allow the passage of the next tray, rotates around the hinge 11 due to the effect of the thrust received by the edge of the same tray, thus positioning itself in the working position due to the effect of its own weight.

The equipment in FIG. 4 is substantially similar to that one in FIGS. 1-3, with the exception that it is conceived for the filling of the trays 5 with sausages 4 having spherical shape.

To such purpose the microprocessor 19 emits a control 20 only after the sensor 7 has detected a pre-established number of passages of sausages 4.

1. Equipment for the automatic tray positioning of single pieces, in particular sausages or other alimentary products, the equipment comprising a first conveyor for the feeding of a sequence of single pieces along a first direction, a second intermittent advancement conveyor for the feeding of single trays along a second direction substantially perpendicular to said first direction, a first sensor for the detection of the passage of the single pieces, a second sensor for the detection of the passage of the single trays, and an electronic control device that receives signals from said sensors and controls an advancement step of said second conveyor, with pre-established delay and in measure at least equal to the width of said pieces, at every pre-established number of passages of the pieces in correspondence of said first sensor and a further advancement step of said second conveyor, up to a position determined by said second sensor and suitable to allow to the next empty tray to receive a first piece from said first conveyor, at each predetermined multiple of said pre-established number of passages of pieces in correspondence of said first sensor, characterised in that said second conveyor has a substantially horizontal path and said first conveyor has an output chute with an output end substantially parallel to the bottom of said trays.

2. Equipment according to claim 1, characterised in that it comprises a blade located at the output of said first conveyor for the alignment of the single pieces at the moment of their entrance into the tray.

3. Equipment according to claim 2, characterised in that said blade is supported by a fixed support so as to be able to oscillate round an axis perpendicular to the advancement direction of said second conveyor.

4. Equipment according to claim 1, characterised in that it comprises a chute located at the output of said first conveyor for the dropping of the single pieces inside the trays.

5. Equipment according to any one of the previous claims, characterised in that said pieces have cylindrical shape.

6. Equipment according to any one of the previous claims, characterised in that said pieces have spherical shape.

7. Equipment according to claim 5 or 6, characterised in that said pieces consist of sausages.
